(19) United States
(12) Patent Application Publication
(10) Pub. No.: US 2008/0075013 A1
(43) Pub. Date: Mar. 27, 2008

(54) APPARATUS AND METHOD FOR PROCESSING CONNECTION FAILURE IN UNLICENSED MOBILE ACCESS (UMA) NETWORK

(75) Inventor: Han-Soo KIM, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/862,902

(22) Filed: Sep. 27, 2007

(30) Foreign Application Priority Data
Sep. 27, 2006 (KR) 2006-0094100

(51) Int. Cl. H04L 12/26

(52) U.S. Cl. 370/242

(57) ABSTRACT

An apparatus and method for connection failure control in an Unlicensed Mobile Access (UMA) network is provided, which includes while providing a current service, determining whether a base station periodically receives a message to determine a lower layer connection status to determine the lower layer connection status, continuously providing the current service if the base station does not receive the message periodically, transmitting a message to inform a connection failure of the lower layer, if the mobile station does not receive the message to inform the connection failure, continuously providing the current service, and if the mobile station receives the message to inform the connection failure, performing a connection failure management process.

### PRIORITY

This application claims priority under 35 U.S.C. § 119(a) to a Korean Patent Application filed in the Korean Intellectual Property Office on Sep. 27, 2006 and assigned Serial No. 2006-94100, the contents of which are incorporated herein by reference.

### BACKGROUND OF THE INVENTION

1. Field of the Invention

The present invention relates to a connection failure control, and in particular, to an apparatus and a method for processing a connection failure in a lower layer of an Unlicensed Mobile Access (UMA) network.

2. Description of the Related Art

The structure of a general related art Unlicensed Mobile Access (UMA) network is illustrated in FIG. 1.

Referring to FIG. 1, a UMA network, like networks such as Bluetooth® and Institute of Electrical and Electronics Engineers (IEEE) 802.11, uses an unlicensed spectrum and accordingly does not need permission to use mobile services such as Global System for Mobile Communications (GSM) or General Packet Radio Service (GPRS). A subscriber is enabled to select between the two types of networks and use not only voice service, but also a data service, using a mobile terminal, which supports both UMA and GSM technologies.

FIG. 2 is a flowchart of a message, illustrating the process of a Transport Control Protocol (TCP) connection failure in a conventional UMA network.

Referring to FIG. 2, the UMA network provides Internet Protocol (IP) based voice and data services. As illustrated in FIG. 3A, Transport Control Protocol (TCP) or User Datagram Protocol (UDP) is adopted for transmission layer protocol.

If a connection failure occurs in a TCP connection as illustrated in FIG. 3B during a provision of service using TCP, a “URR KEEP ALIVE” message, which confirms a lower layer connection between the Universal Network Controller (UNC) 220 and a Mobile Station (MS) 210, is not transmitted, and the following operations are performed, i.e., the MS 210 terminates the TCP connection with the UNC 220. The MS 210 then terminates a security connection with a Secure GateWay (SGW). The MS 210 starts a TU3905 timer, and shifts the status to “URR-DEREGISTERED.”

According to TCP characteristics, if failure occurs in the TCP packet transmission, the packet is retransmitted. The retransmission timeout (RTO), which heavily depends on the packet Round-Trip Time (RTT) of the TCP packet retransmission, is extended up to a maximum of 64 seconds, and the total retransmission timeout is set to approximately 2-9 minutes. In other words, a TCP connection failure occurs if the “URR KEEP ALIVE” message using TCP is not transmitted, and it takes a minimum of 2 minutes to a maximum of 9 minutes for the upper layer of the TCP layer to detect the failure.

Originating or terminating a voice call under the control of the message of the upper layer of the TCP layer is impossible during the above period, and the MS 210 is unable to use the UMA network until it releases the previous connection and completes re-connection.

### SUMMARY OF THE INVENTION

An aspect of the present invention is to substantially solve at least the above problems and/or disadvantages and to provide at least the advantages below. Accordingly, one aspect of the present invention is to provide an apparatus and a method for processing a connection failure in an Unlicensed Mobile Access (UMA) network.

Another aspect of the present invention is to provide an apparatus and a method for rapidly detecting a connection failure of a lower layer in a UMA network.

According to one aspect of the present invention, there is provided a method for processing a connection failure in an Unlicensed Mobile Access (UMA) network, which includes, while providing a voice communication service or a data service, determining whether a base station periodically receives a message to determine a lower layer connection status from a mobile station, if the base station periodically receives the message to determine the lower layer connection status, continuously providing the current service, if the base station does not receive the message to determine the lower layer connection status within the period, notifying the connection failure of the lower layer by transmitting a message to inform the connection failure of the lower layer to the mobile station, if the mobile station does not receive the message to inform the connection failure of the lower layer, continuously providing the current service, and if the mobile station receives the message to inform the connection failure of the lower layer, performing a predetermined connection failure management process.

According to another aspect of the present invention, there is provided a system for processing a connection failure in an Unlicensed Mobile Access (UMA) network, which includes a base station for, while a voice communication service or a data service is being provided, determining whether a message to determine a lower layer connection status is periodically received, and if the message to determine the lower layer connection status is received periodically, continuously providing the current service, and if the message to determine the lower layer connection status is not received within the period, generating a message to inform a connection failure of the lower layer, and a mobile station for, while a voice communication service or a data service is being provided, periodically transmitting a message to determine a lower layer connection status, if a message to inform a connection failure of the lower layer is not received while transmitting the message to determine the lower layer connection status, continuously providing the current service and if the message to inform the connection failure of the lower layer is received while transmitting the message to determine the lower layer connection status, performing a predetermined connection failure management process.

### BRIEF DESCRIPTION OF THE DRAWINGS

The above and other objects, features and advantages of the present invention will become more apparent from the following detailed description when taken in conjunction with the accompanying drawings in which:

FIG. 1 is a view illustrating the structure of a general conventional Unlicensed Mobile Access (UMA) network;

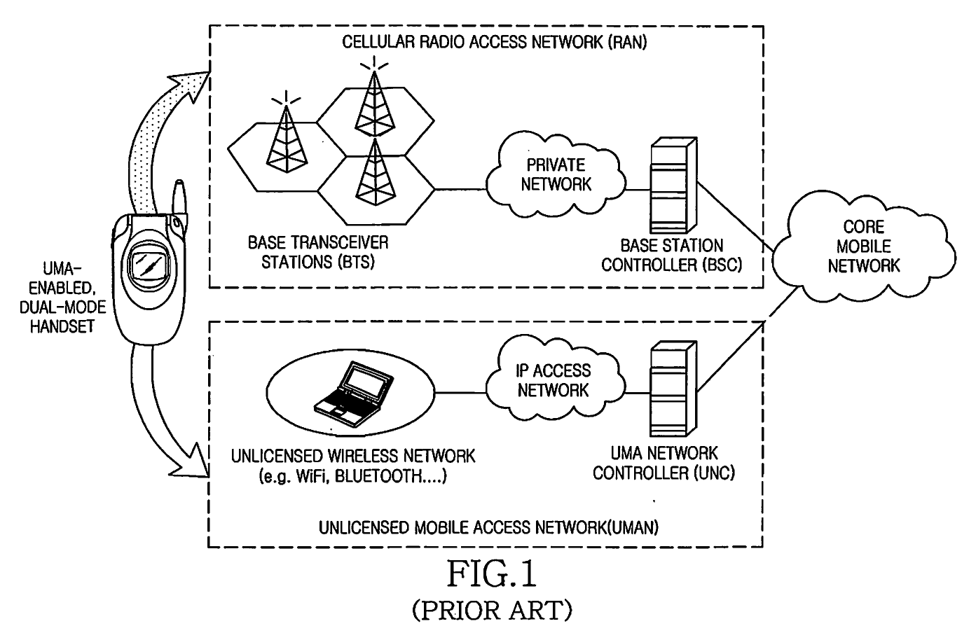

FIG. 2 is a message flowchart of the process of a Transport Control Protocol (TCP) connection failure in a conventional UMA network;

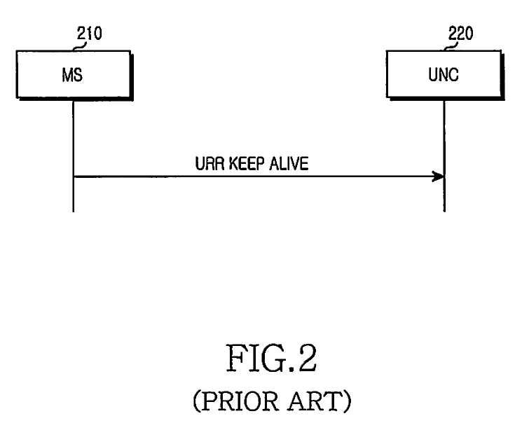

FIGS. 3A and 3B are views illustrating a TCP connection failure of a protocol stack structure of a conventional UMA network;

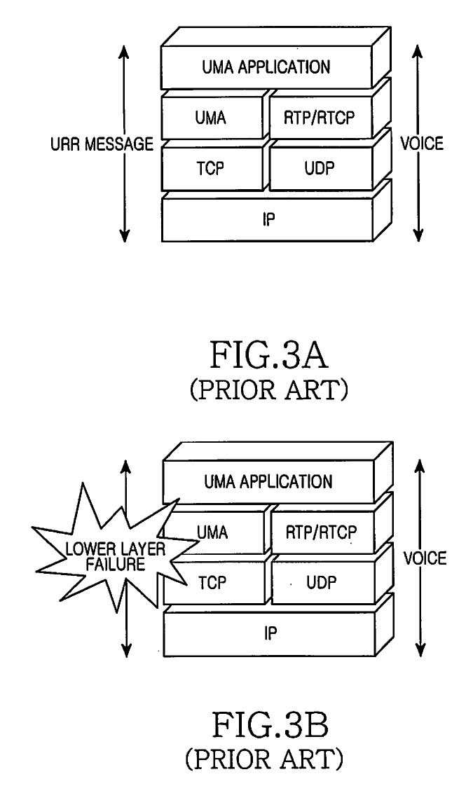

FIG. 4 is a view illustrating the flow of a Real-time Transport Protocol (RTP) packet in a UMA network according to the present invention;

FIG. 5 is a view illustrating a Real-time Transport Control Protocol (RTCP) packet according to the present invention;

FIG. 6 is a view illustrating a TCP connection failure of a UMA network according to the present invention;

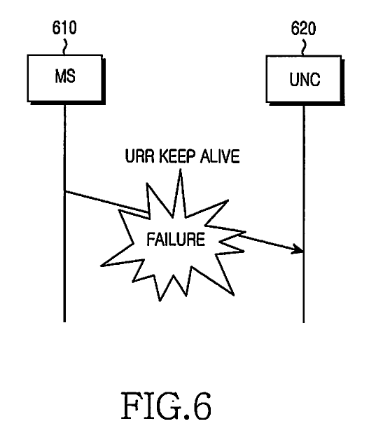

FIG. 7 is a view illustrating the process of TCP connection failure using an RTCP packet in a UMA network according to the present invention;

FIG. 8 is a flowchart of the process of TCP connection failure using an RTCP packet of a base station of a UMA network according to the present invention;

FIG. 9 is a flowchart of the process of TCP connection failure using an RTCP packet of a mobile station of a UMA network according to present invention; and

FIG. 10 is a block diagram of a mobile station and a base station of a UMA network according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

An apparatus and a method for processing connection failure in an Unlicensed Mobile Access (UMA) network according to the exemplary embodiments of the present invention will be explained below.

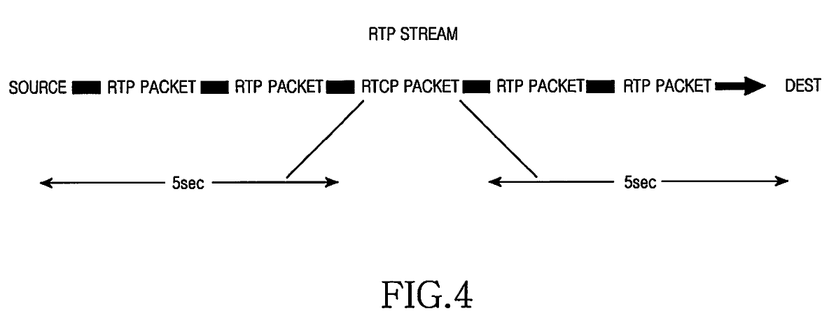

FIG. 4 illustrates the flow of an RTP packet in a conventional UMA network.

Referring to FIG. 4, a mobile station or a base station of a UMA network transmits UMA control messages using a Transport Control Protocol (TCP), and transmits voice packets using Real-time Transport Protocol (RTP) packet which uses User Datagram Protocol (UDP). The mobile station transmits a “URR KEEP ALIVE” message to the base station, periodically, i.e., the mobile station transmits “URR KEEP ALIVE” message every time TU3906 timer expires. If a failure is generated in the TCP connection, according to the TCP characteristics, it is impossible to detect the failure until Retransmission TimeOut (RTO) occurs. Therefore, a Real-time Transport Control Protocol (RTCP) transmission using UDP may be utilized in this situation, in which packets are transmitted to all the participants of the RTP session periodically, for example, in every 5 seconds.

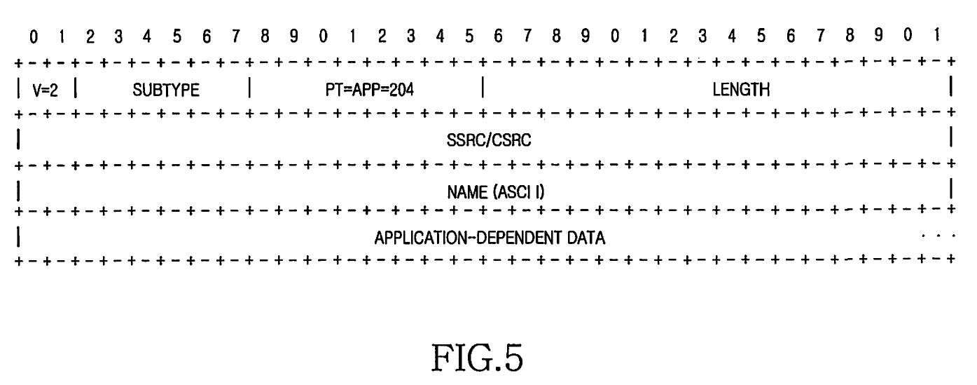

FIG. 5 illustrates an RTCP packet according to the present invention.

Referring to FIG. 5, an RTCP packet format includes APPlication-Defined (APP) RTCP packet format, according to which newly added applications or functions can be used on an Application-Specific basis, i.e., without requiring the registration of the values related with the packet type. According to an aspect of the present invention, the following information may be included in an APP-type RTCP packet, if a problem is generated in the lower layer.

A “Name” field has a length of 4-bytes. This field may include ‘UMA’ to represent that the packet is used in the UMA. “Application-specific Data” field may include “Lower layer failure.” This field is not translated by the RTP, but by the upper layer of the RTP layer to determine that the TCP connection has a problem.

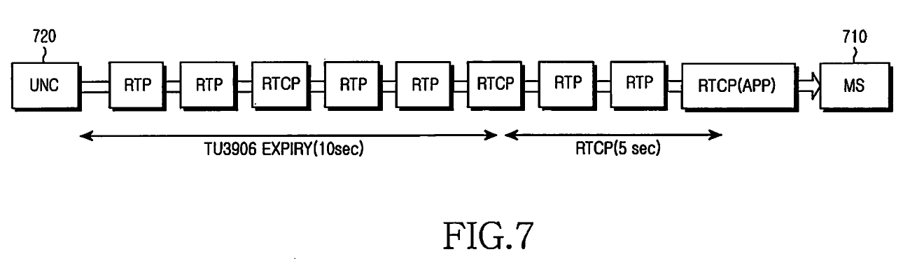

FIG. 7 illustrates the process of TCP connection failure using a RTCP packet in a UMA network according to the present invention.

Referring to FIG. 7, a mobile station 710 transmits a “URR KEEP ALIVE” message to a base station 720, when a TU3906 timer, which is set to expire after 10 seconds according to the present invention, expires, and the base station 720 waits for the reception of the “URR KEEP ALIVE.”

If the “URR KEEP ALIVE” message is not received upon expiration of the TU3906 due to TCP connection failure, the base station 720 converts the RTCP packet, which is transmitted periodically, such as every 5 seconds, into an APP-type RTCP packet, and transmits the APP-type RTCP packet, thereby notifying the mobile station 710 that the lower layer failure has occurred.

The mobile station 710, upon receiving the APP-type RTCP packet, determines that the lower layer failure occurs, and carries out predetermined TCP failure management processes.

FIG. 7 illustrates that the third RTCP packet among the RTCP packets being transmitted every 5 seconds, is replaced by an APP-type RTCP packet and transmitted, after the TU3906 timer expires.

Although an exemplary embodiment of the present invention is explained with reference to an example in which the mobile station 710 receives an APP-type RTCP packet, and the base station 720 transmits the APP-type RTCP packet, an alternative example is also applicable, i.e., it is possible that the base station 720 receives an APP-type RTCP packet, and the mobile station 710 transmits the APP-type RTCP packet, for determination of a connection failure.

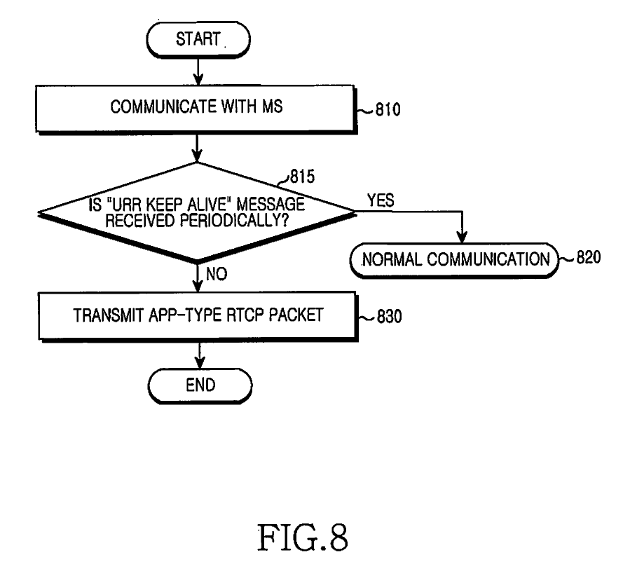

FIG. 8 is a flowchart of the process of TCP connection failure using an RTCP packet of a base station in the UMA network according to the present invention.

Referring to FIG. 8, it is assumed that the base station 720 is capable of conducting communication with the mobile station in step 810.

If the base station periodically receives “URR KEEP ALIVE” messages in step 815, the base station continues the communication in normal manner in step 820. Accordingly, the current communication continues.

If the base station does not receive “URR KEEP ALIVE” messages periodically in step 815, the base station 720 transmits an APP-type RTCP packet to the mobile station to notify that the lower layer failure occurs in step 830.

The process according to the present invention is then terminated.

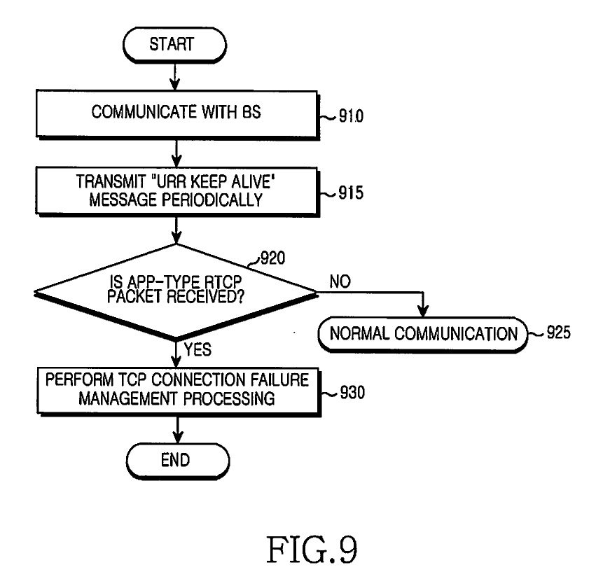

FIG. 9 is a flowchart of the process of TCP connection failure using an RTCP packet of a mobile station of a UMA network according to the present invention.

Referring to FIG. 9, it is assumed that the mobile station 710 is currently in communication with the base station 720 in step 910. The mobile station 710 periodically transmits “URR KEEP ALIVE” messages in step 915.

If the mobile station does not receive an APP-type RTCP packet in step 920, the mobile station continues the normal communication in step 925. Because there is no connection failure generated in the lower layer, the mobile station transmits “URR KEEP ALIVE” messages as in step 915.

If the mobile station 710 receives an APP-type RTCP packet in step 920, the mobile station 710 recognizes that the lower layer failure occurs, and performs predetermined failure management processes to deal with the TCP connection failure in step 930.

The procedure according to the present invention is then terminated.

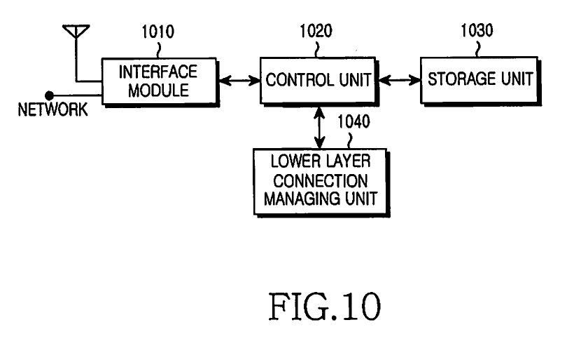

FIG. 10 is a block diagram of a mobile station and a base station of a UMA network according to the present invention.

The structure of the mobile station will be explained with reference to FIG. 10. A control unit 1020 controls the overall operations of the mobile station. For example, the control unit 1020 performs processing and controlling of voice and data communications, and according to the present invention, provides a lower layer connection-managing unit 1040 with the received APP-type RTCP packet to allow the lower layer connection-managing unit 1040 to perform lower layer connection management.

The lower layer connection-managing unit 1040 analyzes the received APP-type RTCP packet and performs the predetermined connection failure management processes, upon determining that the base station notifies with the APP-type RTCP packet that the lower layer connection failure occurs.

A storage unit 1030 operates to store programs to control the overall operations of the nodes, and temporary data generated while the programs are run.

An interface module 1010 enables communication with the base station, and includes an RF processing unit and a base band-processing unit. The RF processing unit converts a signal received through an antenna into a base band signal, provides the base band signal to the base-band-processing unit, converts a base band signal from the base-band-processing unit into an RF signal available for over-the-air transmission, and sends out the RF signal through the antenna.

The structure of the base station will be explained below, with reference to FIG. 10.

The control unit 1020 controls the overall operations of the base station. For example, the control unit 1020 performs processing and controlling of voice and data communications, and according to the present invention, controls the lower layer connection-managing unit 1040 to perform connection management function according to whether the “URR KEEP ALIVE” messages are periodically received.

The lower layer connection-managing unit 1040 monitors to determine whether the “URR KEEP ALIVE” messages are periodically received, and if the “URR KEEP ALIVE” messages are not received within the predetermined period, generates and transmits an APP-type RTCP packet to notify that the lower layer has a connection failure.

The storage unit 1030 operates to store programs to control the overall operations of the nodes, and temporary data generated while the programs are run.

The interface module 1010 enables communication with the mobile station, and includes an RF processing unit and a base-band-processing unit. The RF processing unit converts a signal received through an antenna into a base band signal, provides the base band signal to the base-band-processing unit, converts a base band signal from the base-band-processing unit into an RF signal available for over-the-air transmission, and sends out the RF signal through the antenna.

The base station may further include a module for communication with the upper layer network, in the interface module 1010.

In the mobile station and the base station constructed as explained above, the control unit 1020 controls the lower layer connection-managing unit 1040. In other words, the control unit 1020 may carry out the function of the lower layer connection-managing unit 1040. In the above exemplary embodiment, the lower layer connection-managing unit 1040 is provided separately from the control unit 1020, for the convenience of explanation. In the practical application, however, the control unit 1020 may be configured to process all, or some of the functions of the lower layer connection-managing unit 1040.

According to the present invention explained above, if a lower layer connection failure occurs in a UMA network, the mobile station detects the connection failure rapidly, based on the information provided by the base station. As a result, out-of-service time can be reduced.

Alternate embodiments of the present invention can also comprise computer readable codes on a computer readable medium. The computer readable medium includes any data storage device that can store data that can be read by a computer system. Examples of a computer readable medium include magnetic storage media (such as Read Only Memory (ROM), floppy disks, and hard disks, among others), optical recording media (such as Compact Disk (CD)-ROMs or Digital Versatile Disks (DVDs)), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for processing a connection failure in an Unlicensed Mobile Access (UMA) network, comprising:
transmitting a message periodically to determine a lower layer connection status, while providing a current service,
continuously providing the current service, if a message to inform a connection failure of the lower layer is not received; and
performing a connection failure management process, if the message to inform the connection failure of the lower layer is received.

2. The method of claim 1, wherein the message to inform the connection failure of the lower layer is a Real-time Transport Control Protocol (RTCP) message.

3. The method of claim 1, wherein the message to inform the connection failure of the lower layer includes information indicating that the message is used in the UMA network and information indicating that a lower layer failure occurs.

4. A method for processing a connection failure in an Unlicensed Mobile Access (UMA) network, comprising:
determining whether a message to determine a lower layer connection status is periodically received, while providing a current service;
if the message to determine the lower layer connection status is periodically received, continuously providing the current service; and
if the message to determine the lower layer connection status is not received periodically, transmitting a message to inform the connection failure of the lower layer.

5. The method of claim 4, wherein the message to inform the connection failure of the lower layer is a Real-time Transport Control Protocol (RTCP) message.

6. The method of claim 4, wherein the message to inform the connection failure of the lower layer includes information indicating that the message is used in the UMA network and information indicating that a lower layer failure occurs.

7. A method for processing a connection failure in an Unlicensed Mobile Access (UMA) network, comprising:
determining whether a node periodically receives from a other node a message to determine a lower layer connection status while providing a current service;
if the node periodically receives the message to determine the lower layer connection status, continuously providing the current service;
if the node does not receive periodically the message to determine the lower layer connection status, transmitting a message to inform the connection failure of the lower layer to the other node;
if the other node receives the message to inform the connection failure of the lower layer, performing a connection failure management process; and
if the other node does not receive the message to inform the connection failure of the lower layer, continuously providing the current service;

8. The method of claim 7, wherein the message to inform the connection failure of the lower layer is a Real-time Transport Control Protocol (RTCP) message.

9. The method of claim 7, wherein the message to inform the connection failure of the lower layer includes information indicating that the message is used in the UMA network and information indicating that a lower layer failure occurs.

10. An apparatus for processing a connection failure in an Unlicensed Mobile Access (UMA) network, comprising:
a lower layer connection-managing unit for periodically generating a message to determine a lower layer connection status, while providing a current service; and
an interface module for transmitting the message generated by the lower layer connection-managing unit, receiving a message to inform the connection failure of the lower layer, and providing the lower layer connection-managing unit with the received message.

11. The apparatus of claim 10, wherein the message to inform the connection failure of the lower layer is a Real-time Transport Control Protocol (RTCP) message.

12. The apparatus of claim 10, wherein the message to inform the connection failure of the lower layer includes information indicating that the message is used in the UMA network and information indicating that a lower layer failure occurs.

13. An apparatus for processing a connection failure in an Unlicensed Mobile Access (UMA) network, comprising:
a lower layer connection-managing unit for determining whether a message to determine a lower layer connection status is provided periodically, while providing a current service, if the message to determine the lower layer connection status is not provided periodically, generating a message to inform a connection failure of a lower layer; and
an interface module for transmitting the message generated by the lower layer connection-managing unit, receiving the message to determine the lower layer connection status, and providing the lower layer connection-managing unit with the received message.

14. The apparatus of claim 13, wherein the message to inform the connection failure of the lower layer is a Real-time Transport Control Protocol (RTCP) message.

15. The apparatus of claim 13, wherein the message to inform the connection failure of the lower layer includes information indicating that the message is used in the UMA network and information indicating that a lower layer failure occurs.
